(19) United States
(12) Patent Application Publication
(10) Pub. No.: US 2011/0078614 A1
(43) Pub. Date: Mar. 31, 2011

(54) TERMINAL AND METHOD FOR PROVIDING VIRTUAL KEYBOARD

(75) Inventors: Young Hee LEE, Seoul (KR); Byungsun Kim, Seoul (KR)

(73) Assignee: PANTECH CO., LTD., Seoul (KR)

(21) Appl. No.: 12/780,139

(22) Filed: May 14, 2010

(30) Foreign Application Priority Data
Sep. 30, 2009 (KR) 10-2009-0093472

(51) Int. Cl. G06F 3/048; G06F 3/041

(52) U.S. Cl. 715/773; 345/173

(57) ABSTRACT

A terminal to provide a virtual keyboard includes a touch panel to sense a touch input, a memory unit to store a plurality of virtual keyboards and a touch point number corresponding to each virtual keyboard, a virtual keyboard setting unit to select one of the virtual keyboards corresponding to a touch point number that matches a number of sensed touch inputs, and a display unit to display the selected virtual keyboard. The virtual keyboard setting unit may select one of the virtual keyboards according to a dimension or area of the sensed touch input, and may relocate the virtual keyboard according to coordinates of a touch input.

### CROSS-REFERENCE TO RELATED APPLICATION

This application claims priority from and the benefit of Korean Patent Application No. 10-2009-0093472, filed on Sep. 30, 2009, which is hereby incorporated by reference for all purposes as if fully set forth herein.

### BACKGROUND

1. Field of the Invention

The present invention relates to a user input apparatus, and more particularly, to a terminal to provide a virtual keyboard and a method thereof.

2. Discussion of the Background

A virtual keypad scheme using a touch screen is used for economizing a space for a keypad in a portable terminal. Particularly, in a portable terminal having a touch screen, an is input scheme using the touch screen may supplement or be a replacement for a physical keypad.

However, the virtual keyboard scheme provides a virtual keyboard in a fixed format, and thus, the virtual keyboard format may not consider an inputting habit and intention of a user.

### SUMMARY

Exemplary embodiments of the present invention provide a terminal that adaptively changes and provides a virtual keyboard based on a type, size, or number of a touch input, and a method thereof.

Additional features of the invention will be set forth in the description which follows, and in part will be apparent from the description, or may be learned by practice of the invention.

An exemplary embodiment of the present invention discloses a terminal to provide a virtual keyboard. The terminal includes a touch panel to sense a touch input, a memory unit to store a first virtual keyboard and a second virtual keyboard, a first touch point number corresponding to the first virtual keyboard, and a second touch point number corresponding to the second virtual keyboard, a virtual keyboard setting unit to select the first virtual keyboard or the second virtual keyboard according to whether the first touch point number or the second touch point number corresponds to a number of touch points of the sensed touch input, and a display unit to display the selected virtual keyboard.

An exemplary embodiment of the present invention discloses a method for providing a virtual keyboard on a terminal. The method includes sensing a touch input at a touch panel of the terminal, selecting a first virtual keyboard or a second virtual keyboard according to a number of touch points of the sensed touch input, and displaying the selected virtual keyboard. Here, the terminal stores the first virtual keyboard and the second virtual keyboard, a first touch point number corresponding to the first virtual keyboard, and a second touch point number corresponding to the second virtual keyboard.

An exemplary embodiment of the present invention discloses a terminal to provide a virtual keyboard. The terminal includes a touch panel to sense a touch input on a touch screen, a memory unit to store a plurality of virtual keyboards and corresponding key sizes for the plurality of virtual keyboards; a virtual keyboard setting unit to select a first virtual keyboard from the plurality of virtual keyboards according to a touch area of the touch input, and a display unit to display the first keyboard in the set location.

An exemplary embodiment of the present invention discloses a method for providing a virtual keyboard on a terminal. The method includes sensing a touch input on a touch screen of the terminal, selecting a first virtual keyboard from among a plurality of stored virtual keyboards according to a touch area of the touch input, and displaying the first virtual keyboard.

An exemplary embodiment of the present invention discloses a terminal to provide a virtual keyboard. The terminal includes a touch panel to sense a touch input on a touch screen, a virtual keyboard setting unit to set a location of the virtual keyboard according to coordinates of the touch input, and a display unit to display the virtual keyboard in the set location.

An exemplary embodiment of the present invention discloses a method for providing a virtual keyboard on a terminal. The method includes sensing a touch input on a touch screen of the terminal, setting a location of a virtual keyboard according to coordinates of the touch input, and displaying the virtual keyboard at the set location.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a mobile terminal according to an exemplary embodiment of the present invention.

FIG. 2A, FIG. 2B, and FIG. 2C are diagrams illustrating virtual keyboards set according to a number of touch points according to an exemplary embodiment of the present invention.

FIG. 3A and FIG. 3B are diagrams illustrating virtual keyboards set based on a size of a touch area according to an exemplary embodiment of the present invention.

FIG. 4A and FIG. 4B are diagrams illustrating virtual keyboards set based on a touch location according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

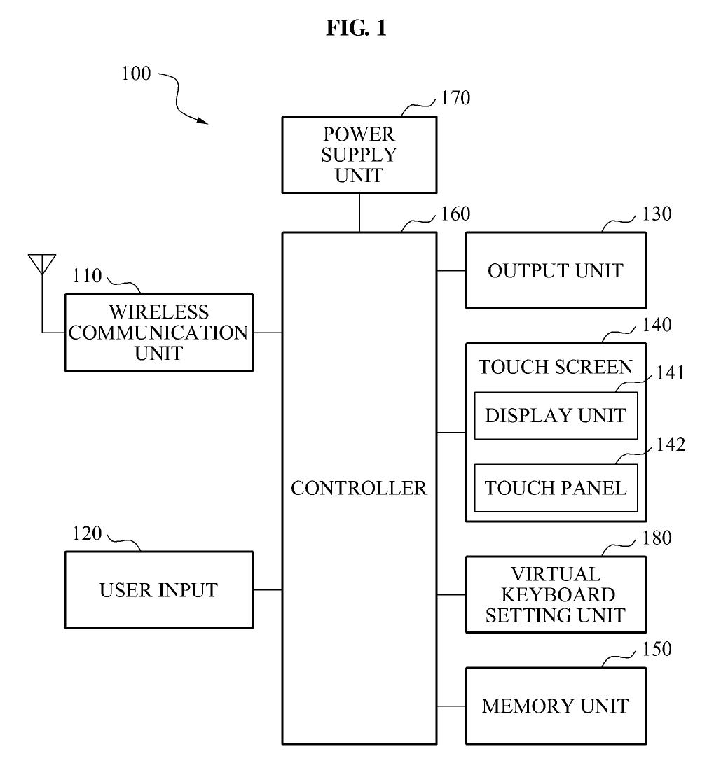

Also, elements described in the present specification are classified based on a main function performed by each element. However, two or more elements may be combined into a single element, or one element may be separately divided into two or more elements based on functions performed by those elements. Each element to be described below may additionally perform all or a part of a function of another element, in addition to its main function. A part of the main function of each element may also be performed by another element. Accordingly, existent of an element described in the present specification may be understood based on a function performed by the element, and thus, a format of a mobile terminal may be different from the exemplary embodiment shown in, for example, FIG. 1 without deviating from the scope of the present invention.

FIG. 1 is a block diagram illustrating a mobile terminal according to an exemplary embodiment of the present invention.

The mobile terminal 100 may include a wireless communication unit 110, a user input unit 120, an output unit 130, a touch screen 140, a memory unit 150, a controller 160, a power supply unit 170, and a virtual keyboard setting unit 180. The touch screen 140 may include a display unit 141 and a touch panel 142. The mobile terminal 100 may also include an interface unit (not shown).

Here, the mobile terminal 100 may be, without limitation, a terminal including a touch screen and may include a communication function, such as a cellular telephone, a mobile PC, a notebook, a PDA, and the like.

In FIG. 1, elements other than the display unit 141, the touch panel 142, and the virtual keyboard setting unit 180 may be general elements that are commonly included in a communication terminal, and the general elements will be briefly described. Also, the virtual keyboard setting unit 180 is displayed as a separate block to clearly distinguish a conventional communication terminal from a terminal that may perform a virtual keyboard setting method based on a type of a touch according to an exemplary embodiment of the present invention. The controller 160 may unify and perform a function and a role performed by the virtual keyboard setting unit 180.

Referring to FIG. 1, the wireless communication unit 110 may include one or more modules that enables a wireless communication of a network between a mobile terminal and a wireless communication system or enables a wireless communication of a network between the mobile terminal and another mobile terminal. As an example, the wireless communication unit 110 may include elements, such as a broadcasting reception module, a mobile communication module, a wireless Internet module, a local communication module, and a location information module, and the like, and may include or be coupled to an antenna.

The user input unit 120 may generate input data for controlling an operation of a terminal. The user input unit 120 may include elements, such as a keypad dome switch jog wheel and a jog switch.

The output unit 130 may generate an output related to a hearing, a sense of touching, and the like. The output unit 130 may include one or more of an acoustic output unit and a haptic module. The acoustic output unit may output audio data stored in the memory unit 150 or audio data received from the wireless communication unit 110 while in a call signal reception mode, a call mode, a recoding mode, a voice recognition mode, a broadcasting reception mode, and the like. The haptic module may output various haptic effects that a user may feel. A vibration may be an example of the haptic effects.

The touch screen 140 may include the display unit 141 and the touch panel 142.

The display unit 141 may display and output information processed in the mobile terminal 100.

As an example, the display unit 141 may display a user interface (UI) or a graphic user interface (GUI) related to a call, when the mobile terminal 100 is in the call mode.

As an example, the display unit 141 may be a liquid crystal display (LCD), and may include a LCD controller, a LCD device, a memory that stores displayed data, and the like.

The touch panel 142 is included in one side of the display unit 141. The touch panel 142 may sense a touch input and may generate a touch signal. Particularly, the touch panel 142 may sense the touch input by detecting a change of a physical quantity, such as a pressure and a capacitance, when the touch input occurs. The touch panel 142 may generate the touch signal by using the change of the physical quantity.

Here, the touch signal may include one or more information among location information of the touch input, information about a duration of time that the touch input is maintained, drag information, information about area that receives the touch input, and pressure information of a touch input.

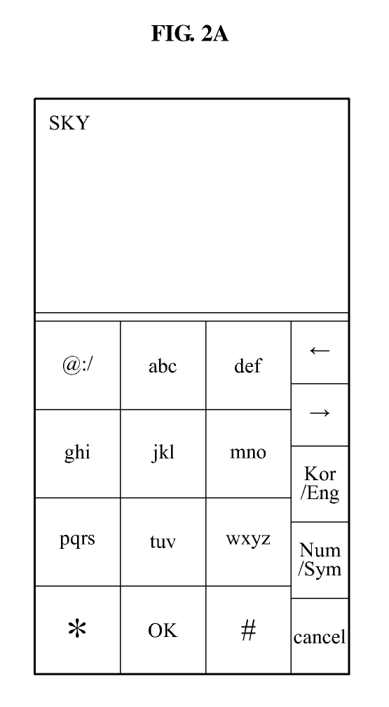

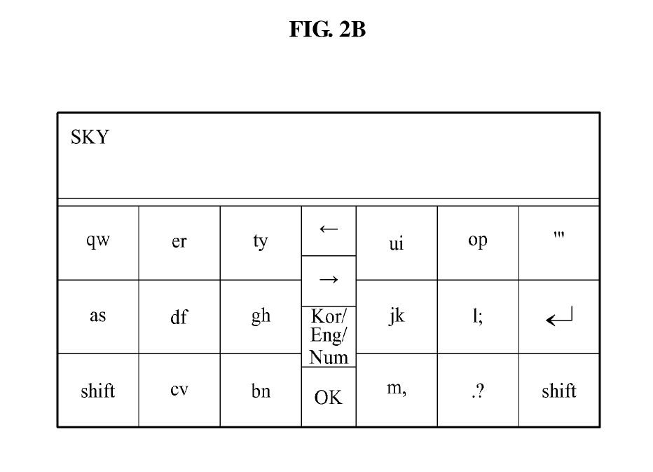

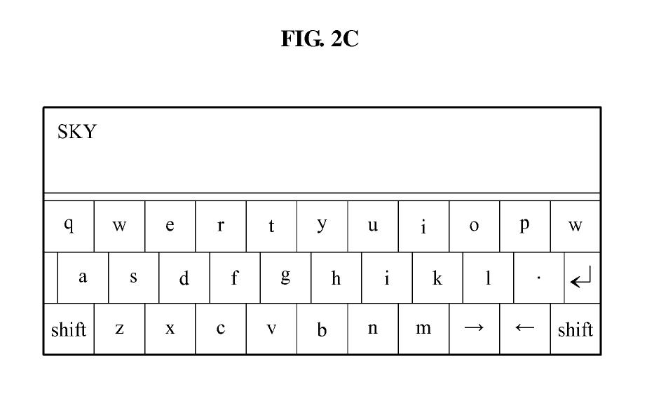

The virtual keyboard setting unit 180 may adaptively set a virtual keyboard according to a type of the touch signal generated by the touch panel 142. As an example, the virtual keyboard setting unit 180 may set a virtual keyboard in which two key pads are located to the left and right side by side, when the touch signal generated by the touch panel 142 is a touch signal identifying that two points are simultaneously touched on the touch panel 142. Subsequently, a processing of setting a virtual keyboard of the virtual keyboard setting unit 180 will be described in more detail with reference to FIG. 2A, FIG. 2B, and FIG. 2C

The memory unit 150 may store a program for operating the controller 160, and may temporarily store input/output data, such as a phonebook, a message, a still image, a moving image, and the like. The memory unit 150 may also store any data to be retrieved by the virtual keyboard setting unit 180.

The interface unit (not shown) may perform as a passage between the mobile terminal 100 and an external device (not shown) that may be connected with the mobile terminal 100.

External power and internal power are provided to the power supply unit 170 by a control of the controller 160, and the power supply unit 170 may provide a power for operating each element.

The controller 160 may control a general operation of the mobile terminal 100. As an example, the controller 160 may control and process a voice communication, a data communication, video and/or sound recording, receiving, and playback, and the like.

FIG. 2A, FIG. 2B, and FIG. 2C are diagrams illustrating virtual keyboards set according to a number of touch points according to an exemplary embodiment of the present invention. Particularly, FIG. 2A illustrates a virtual keyboard where one point is touched, FIG. 2B illustrates a virtual keyboard where two points are simultaneously touched, and FIG. 2C illustrates a virtual keyboard where three or more points are simultaneously touched according to an exemplary embodiment of the present invention.

Referring to FIG. 2A, FIG. 2B, and FIG. 2C, the virtual keyboard setting unit 180 may receive a touch signal generated by the touch panel 142, and may set a virtual keyboard based on a number of touch points that are simultaneously touched by analyzing the touch signal. The number of touch points that are simultaneously touched is referred to as a touch point number. As an example, the virtual keyboard setting unit 180 may determine that the user touches one point based on the touch signal generated by the touch panel 142, and may set a virtual keyboard corresponding to the one-point touch as a virtual keyboard to be used by the mobile terminal 100. FIG. 2A illustrates a virtual keyboard corresponding to a one-point touch, and the keyboard has a format similar to an alpha-numeric key pad which is appropriate for a single finger to touch. That is, the virtual keyboard provided when one point is touched may be selected by an assuming an environment where a hand holds a terminal and a thumb of the hand performs typing. Accordingly, when one point is touched, the virtual keyboard as shown in FIG. 2A including an alpha-numeric key pad structure having a 3×4 arrangement may be provided, the number key pad structure having the 3×4 arrangement being an environment where the user is accustomed to thumb typing.

When the virtual keyboard setting unit 180 determines that a touch point number is two based on the touch signal, namely, when the virtual keyboard setting unit 180 determines that the user simultaneously touches two points, the virtual keyboard setting unit 180 may set a virtual keyboard corresponding to the two-point touch as a virtual keyboard to be used by the mobile terminal 100. FIG. 2B is an example of the virtual keyboard corresponding to two-point touch. As illustrated in FIG. 2B, the virtual keyboard corresponding to the two-point touch may have a format in which keys are bisymmetrically arranged based on a center of the virtual keyboard, and thus, the virtual keyboard has the format that is appropriate for the user to type using two thumbs. Also, a key combination may be permitted in this virtual keyboard arrangement. For example, one thumb may press a shift key and another thumb may press a character key in the virtual keyboard of FIG. 2B, thereby providing a key combination using the shift key. Accordingly, the virtual keyboard may be appropriate for the user who inputs a touch with two thumbs.

When the virtual keyboard setting unit 180 determines that the touch point number is three or more based on the touch signal, the virtual keyboard setting unit 180 may provide a virtual keyboard that is appropriate for an environment where the user puts the terminal on a bracket and performs typing by using both hands. That is, when three or more points are touched, a virtual keyboard having a QWERTY keyboard format as illustrated in FIG. 2C may be provided.

In this instance, when the user touches a virtual keyboard for more than a predetermined time, a touch signal of the virtual keyboard setting unit 180 may determine a touch point number. As an example, when the virtual keyboard setting unit 180 determines that the user presses a single point on the virtual keyboard for more than the predetermined time based on the touch signal, the virtual keyboard may be changed into the virtual keyboard of FIG. 2A. In this instance, when the virtual keyboard setting unit 180 determines that the user presses two points for more than the predetermined time, the virtual keyboard setting unit 180 may change the virtual keyboard into the virtual keyboard of FIG. 2B.

After activating a character input window, the virtual keyboard setting unit 180 may set a virtual keyboard according to a touch point number during the predetermined time. As an example, the virtual keyboard setting unit 180 may set the virtual keyboard based on the touch point number that is initially sensed during the predetermined time after the character input window is opened. Also, the virtual keyboard setting unit 180 may provide a default virtual keyboard when a touch is not sensed during the predetermined time.

The virtual keyboard setting unit 180 may retrieve from the memory unit 150 or may store coordinates information of each key of one or more virtual keyboard and may store a code value corresponding to the pressed key, in advance. The virtual keyboard setting unit 180 may generate an image of the set virtual keyboard, may transmit the image to the display unit 141, and may transmit, to the controller 160, coordinates information and a code value of each key of the virtual keyboard. The display unit 141 may display an image of the virtual keyboard. The controller may identify a key that is pressed by the user, based on the received coordinates information, and may recognize a code value corresponding to the corresponding key as a character inputted by the user.

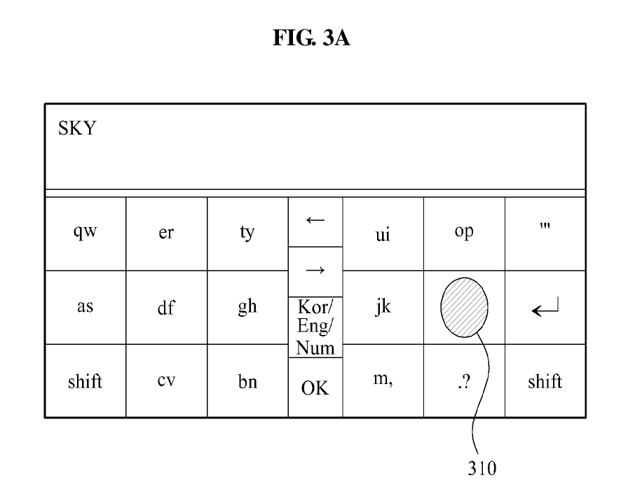

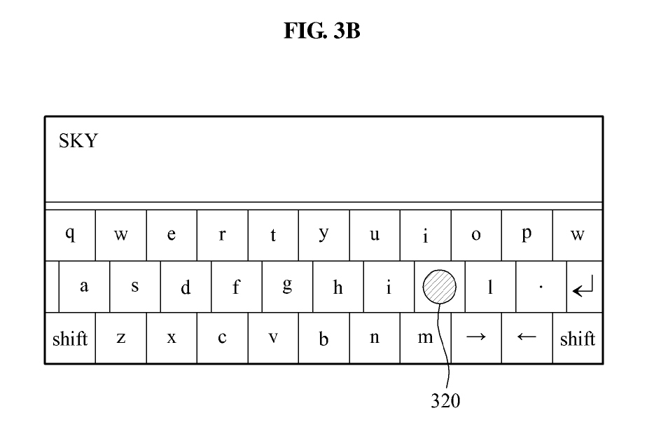

FIG. 3A and FIG. 3B are diagrams illustrating virtual keyboards set based on a size of a touch area according to an exemplary embodiment of the present invention.

Referring to FIG. 3A and FIG. 3B, the virtual keyboard setting unit 180 may calculate a dimension, such as a width or a height, or may calculate an area of a touch area inputted by a touch of the user via the touch panel 142. The virtual keyboard setting unit 180 may store setting information of a plurality of virtual keyboards in advance, and may store a range of the dimension or area of the touch area corresponding to each virtual keyboard. The setting information may define the plurality of virtual keyboards having different sizes of keys from each other.

The virtual keyboard setting unit 180 may compare a width and/or a height of a key constituting each virtual keyboard with a predetermined dimension or a maximum value between a width and a height of the touch area, and may select a virtual keyboard with keys having a size corresponding to the touch area. Therefore, the virtual keyboard setting unit 180 sets the virtual keyboard having keys corresponding to a size of the touch area as a virtual keyboard to be used by the mobile terminal 100.

As an example, when the virtual keyboard setting unit 180 receives a touch from a touch area 310 of FIG. 3A, the virtual keyboard setting unit 180 may compare the touch area length of the touch area 310 with the ranges of the length of the touch area of each virtual keyboard. The virtual keyboard setting unit 180 may select a virtual keyboard having a length range that corresponds to the length of the touch area 310 as a keyboard to be used by the mobile terminal 100.

Similarly, when the virtual keyboard setting unit 180 receives a touch having the touch area 320 of FIG. 3B, the virtual keyboard setting unit 180 may set the virtual keyboard of FIG. 3B, having a length range that corresponds to the length of the touch area 320, as a keyboard to be used by the mobile terminal 100.

A time for setting and changing the virtual keyboard based on a touch input and a process of operating the virtual keyboard have been described with reference to FIG. 2A, FIG. 2B, and FIG. 2C, and thus, a detailed description thereof will be omitted.

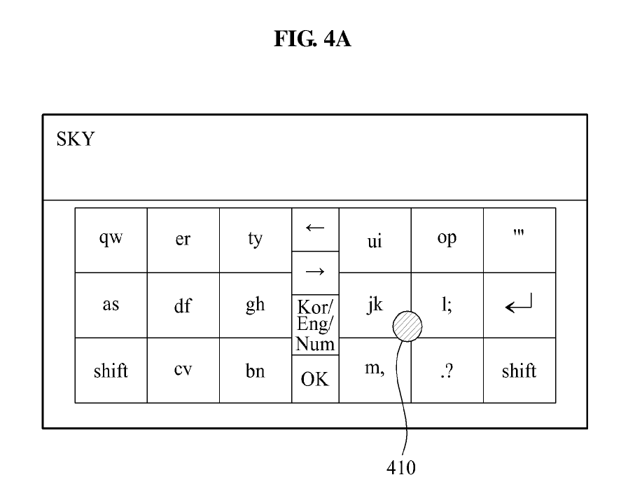

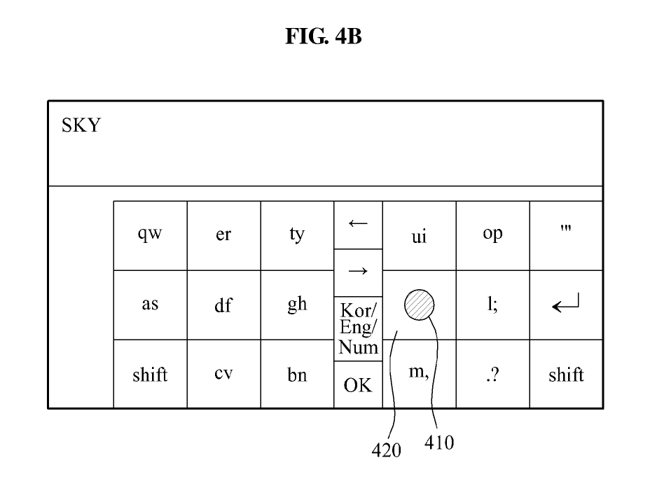

FIG. 4A and FIG. 4B illustrate virtual keyboards set based on a touch location according to an exemplary embodiment of the present invention. FIG. 4A illustrates a virtual keyboard located at default coordinates. FIG. 4B illustrates a virtual keyboard located at moved coordinates.

Referring to FIG. 4A and FIG. 4B, the virtual keyboard setting unit 180 may move a location of the virtual keyboard based on coordinates of a touch input.

As an example, when the virtual keyboard setting unit 180 receives a touch signal corresponding to a touch at the touch area 410, the virtual keyboard setting unit 180 may move the virtual keyboard to move a reference point of the virtual keyboard to a center point of the touch area 410. In the present example, the reference point of the virtual keyboard may be a center of a jk key 420.

As illustrated in FIG. 4B, the virtual keyboard setting unit 180 may move the virtual keyboard so that the center of the jk key 420 corresponds to the center point of the touch area 410 shown in FIG. 4A. In this instance, the virtual keyboard setting unit 180 may additionally reset a size and a location of another UI excluding the moved virtual keyboard. Further, the virtual keyboard setting unit 180 may adjust a size of the moved virtual keyboard so that the entire virtual keyboard is displayed on the display unit 141 while the reference point of the moved virtual keyboard corresponds to the center point of the touch area.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to provide a virtual keyboard, comprising:
a touch panel to sense a touch input;
a memory unit to store a first virtual keyboard and a second virtual keyboard, a first touch point number corresponding to the first virtual keyboard, and a second touch point number corresponding to the second virtual keyboard;
a virtual keyboard setting unit to select the first virtual keyboard or the second virtual keyboard according to whether the first touch point number or the second touch point number corresponds to a number of touch points of the sensed touch input; and
a display unit to display the selected virtual keyboard.

2. The terminal of claim 1, wherein the virtual keyboard setting unit selects the first virtual keyboard if the first touch point number corresponds to the number of touch points of the sensed touch input for more than a predetermined time.

3. The terminal of claim 1, wherein the virtual keyboard setting unit selects the first virtual keyboard if the first touch point number corresponds to the number of touch inputs that is initially sensed after a character input window is activated.

4. The terminal of claim 1, wherein the virtual keyboard setting unit selects a virtual keyboard that has a bisymmetry format if the number of touch points of the sensed touch input is two.

5. The terminal of claim 1, wherein the virtual keyboard setting unit selects a virtual keyboard including a key pad that is capable of receiving an input corresponding to a combination of two keys if the number of touch points of the sensed touch input is two.

6. The terminal of claim 1, wherein the virtual keyboard setting unit selects a virtual keyboard having a QWERTY keyboard format if the number of touch points of the sensed touch input is three.

7. A method for providing a virtual keyboard on a terminal, comprising:
sensing a touch input at a touch panel of the terminal;
selecting a first virtual keyboard or a second virtual keyboard according to a number of touch points of the sensed touch input; and
displaying the selected virtual keyboard,
wherein the terminal stores the first virtual keyboard and the second virtual keyboard, a first touch point number corresponding to the first virtual keyboard, and a second touch point number corresponding to the second virtual keyboard.

8. The method of claim 7, wherein the first virtual keyboard having the first touch point number that corresponds to the number of touch points of the sensed touch input is selected if the sensed touch input is sensed for more than a predetermined time.

9. The method of claim 7, wherein the first virtual keyboard having the first touch point number that corresponds to the number of touch points that is initially sensed after a character input window is activated is selected.

10. The method of claim 7, wherein a virtual keyboard that has a bisymmetry format is selected if the number of touch points of the sensed touch input is two.

11. The method of claim 7, wherein a virtual keyboard including a key pad that receives an input corresponding to a combination of two keys is selected if the number of touch points of the sensed touch input is two.

12. The method of claim 7, wherein a virtual keyboard having a QWERTY keyboard format is selected if the number of touch points of the sensed touch input is three.

13. A terminal to provide a virtual keyboard, comprising:
a touch panel to sense a touch input on a touch screen;
a memory unit to store a plurality of virtual keyboards and corresponding key sizes for the plurality of virtual keyboards;
a virtual keyboard setting unit to select a first virtual keyboard from the plurality of virtual keyboards according to a touch area of the touch input; and
a display unit to display the first virtual keyboard.

14. The terminal of claim 13, wherein the virtual keyboard setting unit selects the first virtual keyboard by comparing a size of a key constituting the first virtual keyboard with a dimension of the touch area.

15. The terminal of claim 13, wherein the virtual keyboard setting unit selects the first virtual keyboard by comparing a size of a key constituting the first virtual keyboard with a greater value among a width and a height of the touch area.

16. A method for providing a virtual keyboard on a terminal, comprising:
sensing a touch input on a touch screen of the terminal;
selecting a first virtual keyboard from among a plurality of stored virtual keyboards according to a touch area of the touch input; and
displaying the first virtual keyboard.

17. The method of claim 16, wherein the first virtual keyboard is selected by comparing a size of a key constituting the first virtual keyboard with a dimension of the touch area.

18. The method of claim 16, wherein the first virtual keyboard is selected by comparing a size of a key constituting the first virtual keyboard with a greater value among a width and a height of the touch area.

19. A terminal to provide a virtual keyboard, comprising:
a touch panel to sense a touch input on a touch screen;
a virtual keyboard setting unit to set a location of the virtual keyboard according to coordinates of the touch input; and
a display unit to display the virtual keyboard in the set location.

20. The terminal of claim 19, wherein the virtual keyboard setting unit sets the location of the virtual keyboard such that a reference point of the virtual keyboard corresponds to the coordinates of the touch input.

21. A method for providing a virtual keyboard on a terminal, comprising:
sensing a touch input on a touch screen of the terminal;
setting a location of a virtual keyboard according to coordinates of the touch input; and
displaying the virtual keyboard at the set location.

22. The method of claim 21, wherein the location of the virtual keyboard is set such that a reference point of the virtual keyboard corresponds to the coordinates of the touch input.
